(19) United States
(12) Patent Application Publication
(10) Pub. No.: US 2005/0266166 A1
(43) Pub. Date: Dec. 1, 2005

(54) Method for coating paper machines

(76) Inventors: Glenn Tiffany Halsey, Mullica Hill, NJ (US); Leonard George Testa, Wilmington, NC (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/138,973

(22) Filed: May 26, 2005

Related U.S. Application Data
(60) Provisional application No. 60/574,691, filed on May 26, 2004.

(51) Int. Cl. B05D 3/02

(52) U.S. Cl. 427/372.2; 162/232

(57) ABSTRACT

A composition that can be used as a coating for paper and paper corrugating rolls comprises a silicone, a solvent, and a catalyst. Also provided is a method for applying a thin, continuous film coating on or onto a surface of a substrate or article. The method comprises combining a silicone, a solvent, and a catalyst to produce a coating composition, applying the coating composition on or onto the surface, and optionally curing the composition.

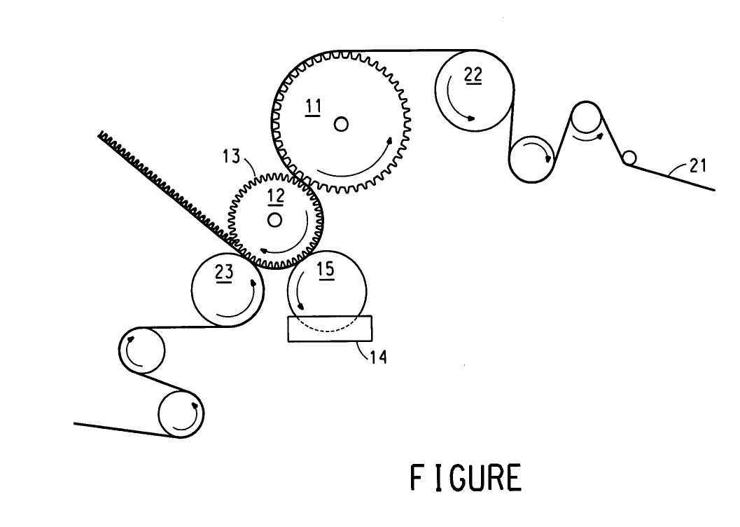

### CROSS-REFERENCE TO RELATED APPLICATION

This application claims priority to U.S. Provisional Application No. 60/574691, filed on May 26, 2004.

### FIELD OF THE INVENTION

This invention relates to a composition that can be used to coat a substrate surface, thereby improving the surface function and extending the life of the surface and more particularly to a method for coating components of a paper machine, including, but not limited to paper rolls and corrugator rolls, by applying a thin, continuous film comprising the composition on the surface of the component.

### BACKGROUND OF THE INVENTION

In a number of commercial operations, a substrate surface, such as, the surface of paper rolls or corrugator rolls is frequently damaged by wear or abrasive substance. Paper rolls and corrugator (or corrugating) rolls are manufactured from stainless steel and the surfaces are usually hardened with proprietary coatings or surface treatments (e.g., chrome, tungsten carbide, etc.) to increase abrasion resistance for extending roll life.

Paper production involves the formation and dewatering of a web primarily composed of cellulose fibers and inorganic filler. The web is formed by spreading an aqueous suspension containing the cellulose fibers and inorganic filler over a wire or net, and then removing water to form a fiber web or sheet. The web or sheet is then passed over “wet end” paper rolls, such as table rolls, couch rolls, and one or more press rolls.

Corrugated paper is generally formed by corrugating a flat sheet of paper, for example, made on a Fourdrinier machine, by passing the flat sheet into a nip formed by two longitudinally toothed rolls rotating in a mesh to form a series of parallel flutes or corrugations in the sheet. The toothed rolls are called corrugator or corrugating rolls. The paper that is corrugated is called the “medium” or “corrugated medium”. One or both sides of the corrugated medium is bonded to flat sheets called “liners” or “facers” or “face sheet” by means of adhesive placed on tips or the outer ridges of the flutes or teeth of the medium or corrugated medium. In a single facer corrugating machine, a liner is applied to one side of the corrugated medium. Corrugated board that is bonded to a liner is called a single-faced corrugated board.

In a conventional corrugating process, the toothed rolls are normally heated to have an operating temperature of about 320-380° F. (160-194° C.). The medium is also typically subjected to preheating on a paper roll to 300-380° F. (148-194° C.), before reaching the corrugator rolls in order to render the medium sufficiently pliable to mold and accept the corrugating stress without fracture or malformation of the flutes in the medium.

Starch or other adhesive is used in the manufacture of corrugated paper to bond the corrugated medium to the liner. In the process of corrugating the medium, adhesive is transferred to the tips of the medium, to enable bonding of the medium to the liner.

At high speeds, which are desirable for optimum productivity, starch tends to splash over equipment, including the corrugator rolls, causing starch to build up unevenly on surfaces. Starch may also enter surface imperfections of surfaces of paper rolls, such as, for example, extremely fine or “hairline” surface cracks that can cause surface chipping due to hardened starch as it expands in these crevices. Starch may adhere to and build up on roll surfaces causing the medium or liner or both to stick to the rolls resulting in wrapping paper around the rolls shutting down production.

Application of coatings in to components of paper machines, and in particularly, paper corrugators, is known. U.S. Pat. No. 3,103,459 discloses application of lubricants such as waxes, asphalt and oils to the medium or directly to corrugator rolls to reduce fracturing of the medium. The fracture problem was not eliminated and use of a lubricant resulted in increased production costs. It is further disclosed therein that application of polyethylene as a surfactant to the paper medium minimizes fracturing.

U.S. Pat. No. 3,676,247 discloses applying a lubricant to one or both sides of the medium prior to corrugation. Effective lubricants include stearin or stearates mixed with paraffin wax or similar materials. It is further disclosed that application of an oil to the pressure roll or directly to a corrugating roll interferes with adhesion of the liner to the medium.

Typical lubricants that have been used as coatings in paper machines include petroleum-based and vegetable-based oils. These oils may be applied, for example, to the surfaces of corrugator rolls to prevent starch from building up. However, due to the temperatures at which paper machines, including paper corrugators, operate, these materials volatilize and create a smoky and unsafe environment as heat is applied to the coated surfaces. These materials also form carbonized deposits on the hot roll surfaces, which are difficult to remove. If excessive amounts are used, the paper becomes spattered, causing unacceptable quality product.

Therefore, there is a need to develop a product or process to provide good surface release and protective coating, to prevent starch from adhering to and building up on surfaces, to prevent paper from wrapping around paper rolls, to eliminate the unsafe and messy application of oil, to manage starch, and to reduce downtime to clean carbonized oil and starch off the rolls. The present invention meets these needs.

### SUMMARY OF THE INVENTION

The present invention provides a coating or release composition comprising a silicone, a solvent, and a catalyst, which is particularly suitable for coating components used in paper machines, especially on paper roll and corrugator roll surfaces and other substrates, which are subject to surface abrasion, for example, as caused by starch-containing adhesives or inorganic particles.

The present invention provides a method for lubricating a paper machine by applying a thin, continuous film coating on or onto a surface of one or more components of a paper machine. The method comprises (a) cleaning the surfaces of components of a paper machine; (b) combining a silicone, a solvent, and a catalyst to produce a coating composition; (c) applying the coating composition to or onto the cleaned surface of a substrate, wherein the substrate is one or more components of a paper machine and (d) optionally curing the composition.

Also provided is a paper machine comprising one or more components having deposited thereon (a) a composition comprising a silicone, a solvent, and a catalyst or (b) a cured composition produced by curing the composition of (a).

### BRIEF DESCRIPTION OF THE DRAWING

The FIGURE shows an example of an arrangement of paper corrugating rolls in a paper corrugator.

### DETAILED DESCRIPTION OF THE INVENTION

Trademarks and trade names used herein are shown in UPPER CASE.

The present invention provides a coating composition comprising a silicone, a solvent and a catalyst. The term “coating composition” can also be referred to as “surface release composition”.

The composition is used in a method of this invention for coating components of a paper machine to facilitate release of materials therefrom. By “paper machine” it is meant to include both a machine that manufactures paper, such as a Fourdrinier machine, as well as a machine that processes paper, such as a paper corrugating machine, also referred to as a paper corrugator. Examples of components of a paper machine having a surface suitable for coating with the composition include but are not limited to, paper rolls, such as, for example, wet end rolls, table rolls, couch rolls and press rolls, dryer cans, and drum dryer rolls. A combination of two or more components may be coated.

Examples of components of a paper corrugator having a surface suitable for coating with the composition include, but are not limited to, corrugator rolls, corrugator fingers, pressure rolls, corrugator pressure belts, Double Backer hot plate/mesh plates, ink pans and glue pans. A combination of two or more components may be coated.

Preferably, according to the method of this invention, the composition is applied to the cleaned surface of paper rolls, drum dryer rolls, corrugator rolls, pressure rolls, pressure belts, corrugator fingers, Double Backer hot plate/mesh plate, glue pan and combinations of two or more thereof. More preferably, the composition is applied to the surface of one or more of paper rolls, drum dryer rolls, corrugator rolls, corrugator fingers, and combinations of two or more thereof. Most preferably, the composition is applied to corrugator rolls.

An example of a set of paper corrugator rolls is shown in the FIGURE where reference numerals 11 and 12 represent paper corrugator rolls. Rolls 11 and 12 comprise a plurality of flutes 13 for making corrugated paper. Reference numeral 14 can be an adhesive reservoir, that is, a glue pan, supplying adhesive such as, for example, starch, to adhesive application roll, or glue roll, 15, which applies melted or molten adhesive to the tips or outer ridges of the flutes of the corrugated medium, that is, the fluted paper, after it has passed the corrugator rolls 11 and 12. During operations, paper 21 passes through a preheater (250-300° F.) or conditioning roll 22 and is pulled through and between rolls 11 and 12, generally at a temperature in the range of from about 50° C. to about 200° C. thereby producing corrugated paper, which passes through a pressure roll 23. Meshing of the heated, fluted rolls bonds the corrugated medium to the liner or face sheet with the adhesive.

The composition of this invention comprises a silicone. The silicone can be a silicone resin, silicone gum, silicone fluid, or combinations of two or more thereof. Such silicones are known in the art and are generally available commercially, for example, from Dow Corning, Midland, Mich. and General Electric Company, Fairfield, Conn. The silicones also can be produced by any methods known to one skilled in the art. For example, the silicone can have the structure of (R₃SiO_{0.5})ₘ(R₂SiO)ₙ(RSiO_{1.5})ₚ(SiO₂)_{q} where each R can be the same or different and is independently selected from the group consisting of hydrogen, a hydrocarbon radical of 1-20 carbon atoms, and combinations of two or more thereof. The radicals can include alkyls, alkenyls, and aryls such as methyl, ethyl, propyl, butyl, vinyl, allyl, phenyl, and combinations of two or more thereof. The subscripts m, n, p, and q comprise the molar ratio of the units with the sum of m, n, p, and q equaling to 1. It can also be a mixture of resins.

Preferably, R is methyl, phenyl or a combination thereof. Generally, at least one of the R groups is phenyl such as, for example, (MeSiO_{3/2}), (MePhSiO_{2/2}), (PhSiO_{3/2}), (Ph₂SiO_{2/2}). More preferably, R is a combination of methyl and phenyl. An example of a preferred silicone is methyl phenyl silicone.

Other silicones can include dialkyl silicone fluids such as dimethyl silicone; aryl silicone fluids such as phenyl silicone; and copolymers of dialkyl silicones and diaryl silicones can also be used in the invention. These silicones are well known to one skilled in the art such as, for example, that disclosed in Kirk-Othmer, Vol. 20, 1982, pages 936-940.

Also suitable as the silicone is a polyorganosiloxane such as, for example, methoxy-terminated polyalkylsiloxanes, hydroxy-terminated polyorganosiloxane, and combinations of two or more thereof. Examples of polyorganosiloxanes include, but are not limited to, polydimethylsiloxanes, polymethylhydrogensiloxanes, polysilsesquioxanes, polytrimethylsiloxanes, polydimethylcyclosiloxanes, and combinations of two or more thereof which can be methoxy-terminated or hydroxyl-terminated, or both. Preferred of this class of silicones is polydimethylsiloxanes.

Each silicone can also contain functional groups such as halide, amine, hydroxy, epoxy, carbinol, carboxylate, acetoxy, alkoxy, acrylate, and combinations of two or more thereof. Preferably the functional group, if present, is an alkoxy group. Preferred alkoxy groups are methoxy and ethoxy. The molecular weight can be in the range of from about 500 to about 1,000,000.

The composition further comprises a solvent. The solvent can be or comprise aromatic hydrocarbon, alkane, alcohol, ketone, ester, ether, glycols, glycol ethers, inorganic solvent, water, and combinations of two or more thereof such as, for example, xylene, benzene, toluene, n-heptane, octane, cyclohexane, dodecane, methanol, ethanol, isopropyl alcohol, acetone, methyl ethyl ketone, dipropylene glycol, dipropylene glycol methyl ether, ethylene glycol n-butyl ether, propylene glycol n-butyl ether, methylene chloride, methylene dichloride, ethylene dichloride, carbon tetrachloride, chloroform, perchloroethylene, ethyl acetate, tetrahydrofuran, dioxane, white spirit, mineral spirits, naphtha, and combinations of two or more thereof.

The solvent can also be or comprise a volatile siloxane. The term “volatile siloxane” refers to a rapidly evaporating siloxane under the temperature and pressure of use. Typically, it can have an evaporation rate of more than 0.01 relative to n-butyl acetate which has an assigned value of 1. A volatile siloxane can have the formula of R¹(R¹₂SiO)ₓSiR¹₃ or (R¹₂SiO)_{y} where each R¹ can be the same or different and can be an alkyl group, an alkoxy group, a phenyl group, a phenoxy group, or combinations of two or more thereof, having 1 to about 10 or 1 to about 8 carbon atoms per group. R¹ can also be a halogen. For example, R¹ can be a methyl group and can be substituted with a halogen, an amine, or other functional group. Subscript x can be a number from about 1 to about 20 or from about 1 to about 10 and y can be a number from about 3 to about 20 or from about 3 to about 10. Such volatile siloxane can have a molecular weight in the range of from about 50 and to about 1,000 and a boiling point less than about 300° C., preferably lower than 250° C., more preferably lower than 200° C., and most preferably lower than 150° C.

Examples of suitable methyl siloxanes include, but are not limited to, hexamethyldisiloxane, hexamethylcyclotrisiloxane, 2,5-dichloro-1,1,3,3,5,5,-hexamethyltrisiloxane, 1,3-dimethyltetramethoxydisiloxane, 1,1,1,3,5,5,5,-heptamethyltrisiloxane, 3-(heptafluoropropyl)trimethysiloxane, octamethyltrisiloxane, octamethyltetrasiloxane, octamethylcyclotetrasiloxane, decamethyltetrasiloxane, decamethylcyclopentasiloxane, dodecamethylpentasiloxane, and dodecamethylcyclohexasiloxane, and combinations of two or more thereof.

In the present invention, solvent selection for use in lubricating a paper-corrugating machine will depend on whether the machine is a hot roll system or a cold roll system. By “cold roll system” it is meant that the machine is off line, that is, not currently set up for operation. An example of a cold roll system is a paper-corrugating machine after manufacture, but not yet in operation, such as at an OEM. By “hot roll system” it is meant that the machine is on line, although not currently operating, for example, a corrugating machine is in a standby “hot” position for short periods during maintenance or shift change. It should be recognized by those skilled in the art that one should never attempt to apply the coating composition as disclosed herein to a paper corrugating machine while in operation.

Generally, there are no restrictions on choice of solvent for use in a cold roll system. In contrast, solvent for use in a hot roll system should have a flash point of at least 100° F. (38° C.), such as glycol ether, for example, ethylene glycol n-butyl ether, dipropylene glycol methyl ether and propylene glycol n-butyl ether. Preferably, the solvent in a hot roll system has a flash point of at least 150° F. (65° C.).

The coating composition can also comprise additional compounds such as modified fumed silica, surfactants, fluoropolymers such as polytetrafluoroethylene, waxes, fatty acids such as stearic acid, fatty acid salts such as metal stearates, finely dispersed solids such as talc, emulsifiers, biocides, corrosion inhibitors.

Each component disclosed above can be present in the composition in an effective amount sufficient to effect the production of a coating composition. For example, based on the total weight of the composition, the solvent can be present in the composition in the range of from about 1 to about 99%, relative to the total weight of the composition, preferably from about 10 to about 99%. The solvent makes up the balance of the composition. A silicone can be present in the composition in the range of from about 0.01 to about 99%, relative to the total weight of the composition. More typically, a silicone is present in an amount of 0.1 to about 10%, preferably about 0.5 to about 5%. Additional compounds, if present, can be in the range of from about 0.01 to about 20%, typically, 0.05 to 5%, relative to the total weight of the composition.

The composition comprises a catalyst. Any catalyst that can catalyze or enhance the curing of the coating composition disclosed above can be used herein. An example of catalyst is one or more zirconium compound, titanium compound, or combinations thereof. Examples of suitable catalysts include, but are not limited to, zirconium or titanium or those expressed by the formula M(OR²)₄ where M is zirconium or titanium and each R² is individually selected from an alkyl, cycloalkyl, alkaryl, hydrocarbyl radical containing from about 1 to about 30, preferably from about 2 to about 18, and more preferably about 2 to about 12 carbon atoms per radical and each R² can be the same or different. Specific examples of catalysts include, but are not limited to, zirconium acetate, zirconium propionate, zirconium butyrate, zirconium hexanoate, zirconium 2-ethyl hexanoate, zirconium octoate, tetraethyl zirconate, tetrapropyl zirconate, tetraisopropyl zirconate, tetrabutyl zirconate, titanium acetate, titanium propionate, titanium butyrate, titanium hexanoate, titanium 2-ethyl hexanoate, titanium octoate, tetraethyl titanate, tetrapropyl titanate, tetraisopropyl titanate, tetrabutyl titanate, and combinations of two or more thereof. Preferred are tetraethyl titanate, tetrapropyl titanate, tetraisopropyl titanate, tetrabutyl titanate, and combinations of two or more thereof. These catalysts are commercially available.

Other suitable catalysts include a compound or element of VIII group of the periodic table of the elements such as platinum, palladium, iron, zinc, rhodium, and nickel as well as a tin or zirconium compound. Examples of other suitable catalysts include, but are not limited to, dibutyltin diacetate, dibutyl dilaurate, zinc acetate, zinc octoate, and combinations of two or more thereof. For example, dibutyltin diacetate can be used independently or in combination with a titanium compound.

Each of the catalysts disclosed above can be used in the composition in the range of from about 0.001 to about 10% relative to the total weight of the composition, preferably from about 0.1 to about 0.4%.

The method for lubricating a paper machine comprises applying a thin, continuous film coating on or onto a cleaned surface of one or more components. The method comprises (a) cleaning a surface of one or more components of a paper machine; (b) combining solvent, silicone, and catalyst to produce a coating composition, (c) applying the coating composition to or onto the surface of a substrate, wherein the substrate is one or more components of a paper machine, and optionally (d) curing the composition.

The method comprises cleaning the components prior to applying the composition to the components. Cleaning may comprise contacting the components with a detergent, preferably a strong detergent, as are known by those skilled in the art as typically, although not exclusively, as having a pH above 9, or even having a pH of above 10. Preferably, the detergent is dissolved in water, and most preferably the detergent is dissolved in warm or hot water. The detergent can be any of a number of commercially available strong detergents, such as, for example, SIMPLE GREEN All Purpose Cleaner, available from Sunshine Makers, Inc., Huntington Harbour, Calif. Depending on the condition of the components, cleaning with a detergent may comprise scrubbing, such as with a stiff bristled brush. After cleaning with detergent, components are rinsed with water. Alternatively, cleaning may comprise low or high-pressure water washing of the components. Cleaning may further comprise contacting the components with an oil-solubilizing solvent, such as an alcohol. After cleaning, the components may be dried, for example, allowing to sit until water or solvent has evaporated or wiping with a cloth.

Combining silicone, solvent, and catalyst can be carried out by any means known to one skilled in the art such as, for example, mixing the silicone, solvent and catalyst together, at any suitable temperature such as from about 0° C. to about 200° C., under a pressure that can accommodate the temperature, and for a sufficient period of time to effect the production of the composition such as from about 0.5 minute to about 10 hours.

Applying the coating composition can be carried out by any means known to one skilled in the art such as, for example, spraying, brushing, wiping, dipping, and combinations of two or more thereof. When applying the coating composition to corrugator rolls, care should be taken to ensure the rolls are completely coated. Preferably, a thicker coating should be applied to the ends of the rolls that are more susceptible to building up of starch and carbonized oil.

Curing can be carried out by any means known to one skilled in the art such as curing at ambient temperature such as from about 25° C. to about 250° C., preferably from about 100° C. to about 225° C., and more preferably about 150° C. to about 200° C., under a pressure that accommodates the temperature range such as, for example, atmospheric pressure for about one second to about 2 hours.

Also disclosed is a substrate comprising a surface or a portion of the surface coated with a composition. The substrate and composition are as disclosed above.

### EXAMPLES

### Example 1

The effectiveness and durability of CORRSURFACE PROTECT 2224, available from E. I. du Pont de Nemours and Company, Wilmington, Del., as a coating was evaluated following the test method documented by Kathleen Shields, et al., in Rubber World, January, 1998. This test had been found to provide a good indication of the relative effectiveness of an anti-stick or release coating.

The test measures the force required to remove a simulated molded compound from a coated substrate. Each test cycle represents three individual pulls to remove the molded compound, and the force of each pull is averaged to provide an average force for the cycle. When the average force exceeds 4 lbs. on two consecutive determinations, the coating is considered “failed”.

CORRSURFACE PROTECT 2224 was applied to a 3″×6″ 316 stainless steel plate, and the coating cured at 170° C. (338° F.) for 90 minutes. The coating was transparent and colorless. The coated plate was then tested on an Altek Tester, according to the test method as described by Shields, et al., in the aforementioned reference, using SUREBONDER All Purpose/All Temperature hot glue, available from FPC Corporation, Wauconda, Ill., as the simulated molding compound. After 93 release cycles, the average ejection force was less than 0.5 lbs, well below the test failure limit of 4 lbs. The CORRSURFACE PROTECT 2224 coating was still intact and performing at a high level. Ejection forces were low, indicating excellent ease of release, and the coating was durable having achieved 93 release cycles with no indication of coating failure.

In a comparison, the process was repeated with a semi-permanent release coating, McLUBE MAC444 (available from McGee Industries, Aston, Pa.). This coating provided 10-15 releases before failing, typical for these types of coatings.

The process was repeated with an unusually good semi-permanent release coating, TRASYS 428, available from E. I. du Pont de Nemours and Company, Wilmington, Del. This coating provided 40 releases in this test.

### Example 2

### Test Procedure

CAUTION: lock and tag procedures should be followed for safety so that the equipment cannot be accidentally started and/or operated. Rolls should also sufficiently cool to permit contact with water cleaners, etc. in a safe manner.

The following operations should be performed in an area where there is good ventilation, especially when applying the CORRSURFACE PROTECT 2224 coating.

The following discussion is based on the roll configuration in the FIGURE. Separate the rolls in accordance with machine design. Some machines have this capability and can be done automatically; others will need the rolls to be separated manually. For manual separation, lift air cylinder and insert a wedge between roll linkages, undoing bolts to loosen the rolls, if necessary. The rolls should be sufficiently separated so that daylight can be seen between the rolls.

Back away the pressure roll 23 to access corrugator rolls.

Clean the rolls as follows. Prepare a cleaning solution containing either warm or hot water and SIMPLE GREEN All Purpose Cleaner, available from Sunshine Makers, Inc., Huntington Harbour, Calif. Clean the rolls by either scrubbing the rolls using a stiff bristled brush and the detergent solution or using a pressure washer and the detergent solution. It is important that no oil remains on the roll surfaces or within pores on the roll surfaces. Rolls may be rotated by using a “helper” or “pry bar” to rotate the upper roll 11. The lower roll 12 is rotated by either turning the power on and off or “jogging” the roll to the adjacent area. Remaining oil may be removed by a final cleaning, using a scouring pad and denatured alcohol. Dry the rolls with a cloth towel.

For convenience, the clean, dry rolls should be marked at an outer edge, for example with a black felt marker to identify a starting point for application of the lubricating composition in this invention, so that one knows when the rolls are completely covered.

The machine should be placed into operation and the rolls heated to a temperature of at least about 300° F. (149° C.).

Apply a CORRSURFACE PROTECT 2224 coating in an area with good ventilation. Ventilation may be provided by positioning a fan on the floor along side of the single facer so that it blows fresh air throughout the application area.

Beginning with the upper corrugator roll 11, which should be freely rotatable, apply a heavy spray of the CORRSURFACE PROTECT 2224 to the exposed section, making sure to wet-out the surface. The ends of the rolls, about a 4-inch band at each end, are given a heavier coating. Using a “pry bar” or large pipe wrench on a journal, turn the roll and repeat the process until the roll is completely coated, using outer marked edge as a guide.

After marking with a black felt marker, as for roll 11, spray a heaving coating of CORRSURFACE PROTECT 2224 on the exposed surface of the lower roll 12. Turn on the power and jog the roll 12 to the next section and repeat with heavy spray coating. Continue to coat and jog until lower roll 12 is completely coated. A heavier coating should be applied in a 4-inch band at each end of the roll 12. The ends of the rolls 11 and 12 are exposed and receive spray of starch from reservoir onto which dust and debris become attached.

NOTE: if spotting appears, that is, the coating appears to stain either the upper or lower roll, it is an indication that the roll was not sufficiently cleaned. The roll should then be brushed to loosen coating and residue, followed by high pressure water washing or wiping with a wet cloth, as is needed. Additional dirt/residue may be observed washing off the roll. The CORRSURFACE PROTECT 2224 coating should then be applied as discussed above, taking special care to note where the spotting had occurred to ensure the roll was sufficiently cleaned.

After the coating has been applied, it is cured by letting the rolls stand for at least sixty (60) minutes at operating temperature 350°-400° F. (177°-204° C.).

Optionally, an additional light spray of the coating CORRSURFACE PROTECT 2224 may be applied to the ends of each roll to enhance anti-stick benefits, with a second cure for an additional 60 minutes.

To minimize the time that the rolls run without paper, the web or liner may be wrapped back over the pressure roll 23 while the coating is applied to the corrugator rolls.

Paper is fed after the coatings have cured, and time the flute teeth rub against each other should be minimized to minimize abrasion of the coating and extend coating life.

NOTE: If after curing, the upper corrugator roll 11 cannot be separated from the lower corrugator roll 12, apply CORRSURFACE PROTECT 2224 to the exposed area where the rolls are in contact or to both corrugator rolls on one side of a “cart”, that is, a standby set of corrugator rolls, and work to rotate the treated surfaces away from each other so that the “uncured” treated surfaces to do rub against each other. Cure newly applied coating according for 60 minutes.

### Test Results

The test method as described above was conducted in an operating corrugating paperboard plant on a corrugating machine. Initially, the machine had been operating with a lubricant applied to corrugator rolls which was a petroleum-based hydraulic oil, RANDO 46 available from Chevron Corp., San Ramon, Calif. Observations included the following. Cleaning between oil applications was difficult using detergent, brushing and low-pressure water. After application of the oil, under temperatures of heating and operation from 320° F. (160° C.) to 380° F. (194° C.), the smell of oil fumes was detected and smoke was observed at the machine. Haze was observed in the plant after application of the oil. Oil spotting on the paper occurred with a loss of about 20 meters of paper.

The machine was then cleaned to remove any of the remaining oil. Rolls were separated and cleaned as described above, including the optional step of wiping with denatured alcohol. A black magic marker was used to mark the starting flute on each corrugator roll prior to applying CORRSURFACE PROTECT 2224. The coating was applied horizontally across the flutes in an amount of about 0.5 liter per roll. After application of the CORRSURFACE PROTECT 2224, no fumes were detected. No smoke was observed at the machine. Paper was not lost due CORRSURFACE PROTECT 2224 spotting. Subsequent cleaning of the rolls was significantly faster and easier than when hydrocarbon-based oil had been used. After using the CORRSURFACE PROTECT 2224 cleaning time was reduced to a few minutes versus several hours required using hydrocarbon-based oil.

### Example 3

The process of Example 2 was repeated to apply CORRSURFACE PROTECT 3622, available from E. I. du Pont de Nemours and Company, Wilmington, Del., to glue pan, except that the curing step was omitted. Due to their operation only during daytime, glue pans were cleaned once everyday at the end of the day. Cleaning was performed using high-pressure water. Application of CORRSURFACE PROTECT 3622 resulted in a more facilitated cleaning operation. That is, it was easier to clean glue pan treated with CORRSURFACE PROTECT 3622 than non-treated glue pans.

1. A method for lubricating one or more components of a paper machine comprising (a) cleaning a surface of one or more components of a paper machine; (b) combining a silicone, a solvent, and a catalyst, to produce a coating composition; and (c) applying said composition on or onto a surface of a substrate wherein the substrate is one or more components of a paper machine.

2. A method according to claim 1 further comprising curing said composition.

3. A method according to claim 1 or 2 wherein the composition further comprises one or more of modified fumed silica, surfactants, fluoropolymers, waxes, fatty acids or fatty acid salts, talc, emulsifier, biocide, or corrosion inhibitor.

4. A method according to claim 1 wherein said composition is applied to the surface of one or more of wet end rolls, table rolls, couch rolls, press rolls, dryer cans, and drum dryer rolls.

5. A method according to claim 1 wherein the composition is applied to the surface of corrugator rolls, corrugator fingers, pressure rolls, corrugator pressure belts, Double Backer hot plate/mesh plates, ink pans and glue pans or a combination of two or more thereof.

6. A method according to claim 4 or 5 wherein the composition is applied to the surface of paper rolls, drum dryer rolls, corrugator rolls, pressure rolls, pressure belts, corrugator fingers, Double Backer hot plate/mesh plate, glue pan and combinations of two or more thereof.

7. A method of claim 6 wherein the composition is applied to the surface of paper rolls, drum dryer rolls, corrugator rolls, corrugator fingers, and combinations of two or more thereof.

8. A method according to claim 7 wherein the composition is applied to the surface of corrugator rolls.

9. A method according to claim 1 wherein cleaning comprises contacting said components of said paper machine with a detergent.

10. A method according to claim 1 wherein cleaning comprises low or high-pressure water washing of said components of said paper machine.

11. A method according to claim 1 or 2 wherein the silicone has the structure of (R₃SiO_{0.5})ₘ(R₂SiO)ₙ(RSiO_{1.5})ₚ(SiO₂)_{q} where each R can be the same or different and is independently selected from the group consisting of hydrogen, a hydrocarbon radical of 1-20 carbon atoms, and combinations of two or more thereof.

12. A method according to claim 11 wherein the silicone R is methyl, phenyl or a combination thereof.

13. A method according to claim 12 wherein the silicone is methyl phenyl silicone.

14. A method according to claim 1 or 2 wherein the paper machine is a hot roll system corrugating machine and the solvent has a flash point of at least 100° F. (38+ C.).

15. A method according to claim 15 wherein the solvent has a flash point of at least 150° F. (65° C.).

16. A method according to claim 16 wherein the solvent is dipropylene glycol methyl ether.

17. A paper machine comprising one or more components having deposited thereon (a) a composition comprising a silicone, a solvent, and a catalyst or (b) a cured composition produced by curing the composition of (a).

18. A paper machine according to claim 17 wherein said component is a paper-corrugating roll.
